(19) United States
(12) Patent Application Publication
(10) Pub. No.: US 2006/0136620 A1
(43) Pub. Date: Jun. 22, 2006

(54) DATA TRANSFER INTERFACE APPARATUS AND METHOD THEREOF

(76) Inventor: Yu-Pin Chou, Miao- Li Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,109

(22) Filed: Dec. 16, 2004

(51) Int. Cl. G06F 3/06

(52) U.S. Cl. 710/58; 710/52

(57) ABSTRACT

A data transfer interface apparatus and method for controlling data transfer. The data transfer interface apparatus includes a first storage unit for storing an input data according to a first clock and for outputting a first output data according to a second clock, a single-port memory coupled to the first storage unit for storing the first output data according to the second clock and for outputting a second output data according to the second clock, and a second storage unit coupled to the single-port memory for storing the second output data according to the second clock and for outputting a third output data according to a third clock.

### BACKGROUND OF INVENTION

1. Field of the Invention

The invention relates to a data transfer method and apparatus, and more particularly, to a data transfer interface apparatus with a small chip area for controlling data transfer and method thereof.

2. Description of the Prior Art

An important component in electronics is a data transfer interface device. A data transfer interface device performs the important task of transferring and buffering data output from a device A to a device B. Oftentimes, the data from the device A cannot be directly transferred into the device B because of different operating environments in the devices A and B (e.g. the operating frequencies of device A and device B differ), thus necessitating the presence of the data transfer interface device. For instance, the data transfer interface device functions as a buffer positioned between the device A and the device B for coordinating data transfer in different clock domains.

Presently, the most common embodiment of a data transfer interface device is a first in/first out (FIFO) storage unit. The FIFO storage unit accepts data inputted at a first frequency and outputs data at a second frequency. Among the drawbacks of such an FIFO storage unit that buffers data delivered between two devices, the two more prominent ones are the expense and the chip size taken up by the FIFO storage unit. While expense is a self-explanatory disadvantage, size is a disadvantage because space on the circuit board is at a premium. Bigger chip size means less space available for other parts. In other words, if the FIFO storage unit is used to implement the data transfer interface device, the size of the circuit board is required to be big enough to accommodate the installed FIFO storage unit.

### SUMMARY OF INVENTION

It is therefore one of the many objectives of the claimed invention to provide a data transfer interface device and method thereof.

According to the claimed invention, a data transfer interface apparatus is disclosed. The data transfer interface apparatus comprises a first storage unit for storing an input data according to a first clock and for outputting a first output data according to a second clock, a single-port memory coupled to the first storage unit for storing the first output data according to the second clock and for outputting a second output data according to the second clock, and a second storage unit coupled to the single-port memory for storing the second output data according to the second clock and for outputting a third output data according to a third clock.

Also according to the claimed invention, a data transfer interface apparatus is disclosed. The data transfer interface apparatus comprises a single-port memory for storing an input data according to a first clock and for outputting a first output data according to a second clock; and a dual-port memory coupled to the single-port memory, for storing the first output data according to the second clock and for outputting a second output data according to a second clock.

Further according to the claimed invention, a data transfer interface apparatus is disclosed. The data transfer interface apparatus comprises a dual-port memory for storing an input data according to a first clock and for outputting a first output data according to a second clock; and a single-port memory coupled to the dual-port memory, for storing the first output data according to the second clock and for outputting a second output data according to the second clock.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a data transfer interface device according to a first embodiment of the present invention.

FIG. 2 is a schematic diagram illustrating the data transfer interface device applied in the display or television field.

FIG. 3 is a block diagram of a data transfer interface device according to a second embodiment of the present invention.

FIG. 4 is a block diagram of a data transfer interface device according to a third embodiment of the present invention.

FIG. 5 is a block diagram of a data transfer interface device according to a fourth embodiment of the present invention.

### DETAILED DESCRIPTION

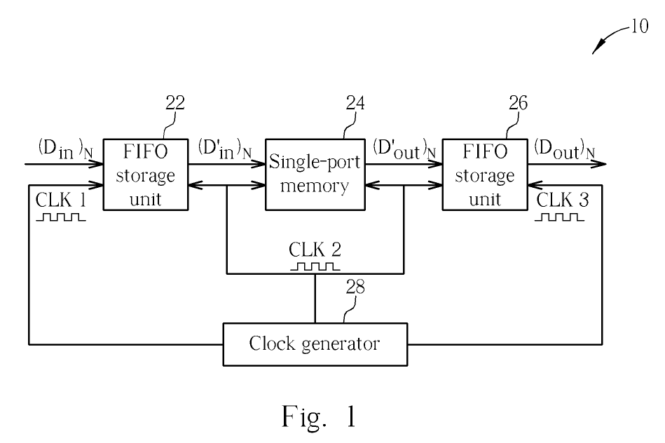

Please refer to FIG. 1. FIG. 1 is a block diagram of a data transfer interface device 10 according to an embodiment of the present invention. In this preferred embodiment, the data transfer interface device 10 comprises two asynchronous storage units (the FIFO storage units 22 and 26) and a single-port memory 24. The two FIFO storage units 22, 26, and the single-port memory 24 are clocked to receive and output data according to clock signals generated by a clock generator 28, whereof details will be described hereinafter shortly. Please note that the FIFO storage units 22, 26 can be embodied by dual-port memories. In addition, one can also choose to implement the FIFO storage units 22, 26 by using latch circuits instead, wherein the substitution of FIFO by latch-based circuits is considered well known in the pertinent art. Meanwhile, the single-port memory 24 can be embodied by a well-known SRAM. These are only examples of the FIFO storage units 22, 26 and the single-port memory 24, and are not meant to be taken as limitations.

The term “single-port memory” or “single-port storage unit” herein, as one of ordinary skill in the art would understand, refers to a storage device having only one port for input/output, which implies a input/output mutual exclusion characteristic, which means the input operation cannot happen when outputting, and vice versa. The term “dual-port memory” or “dual-port storage unit”, on the other hand, refers to a storage device having two ports for accessing, and therefore capable of simultaneous input/output operation. Because of the simultaneous input/output accessing characteristics, a dual-port memory is considered capable of being accessed “asynchronously”, and thus the term “asynchronous storage unit”.

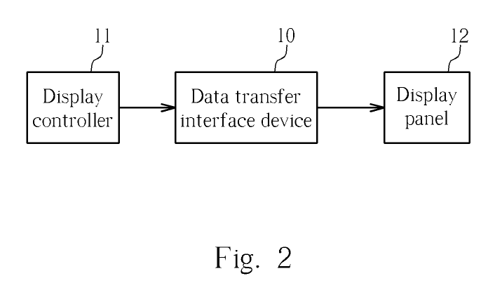

The data transfer interface device described in the embodiments of the present invention can be used in a variety of applications. For example, it can be used as buffer memory, such as a frame buffer, between display controller and display panel. Pertinent products may include LCD monitor controllers, LCD TV controllers, digital TV controllers, and the like. Please refer to FIG. 2, which schematically illustrates such a setup in the display or television field. As shown in FIG. 2, the data transfer interface device 10 is positioned between a display controller 11 and a display panel 12.

The single-port memory 24 is positioned between the two FIFO storage units 22, 26. For the FIFO storage unit 22, data (Dᵢₙ)_{N} with a data width N is received according to a clock CLK₁ and data (D′ᵢₙ)_{N} with the same data width N is output according to a different clock CLK₂. For the single-port memory 24, data (D′ᵢₙ)_{N} output from the FIFO storage unit 22 is received according to the clock CLK₂, and data (D′ₒᵤₜ)_{N} with the same data width N is output according to the clock CLK₂. Finally, for the FIFO storage unit 26, data (D′ₒᵤₜ)_{N} output from the single-port memory 24 is received according to the clock CLK₂ and data (Dₒᵤₜ)_{N} with the same data width N is output according to a different clock CLK₃. For this preferred embodiment, the clocks CLK₁, CLK₂, and CLK₃ have different frequencies. In other words, the data transfer interface device 10 according to the preferred embodiment operates under different clock domains defined by these clocks CLK₁, CLK₂, and CLK₃.

Please note that the FIFO storage units 22, 26 are able to read and write data simultaneously while the single-port memory 24 is only able to read data or write data but not both at the same time. Because of this, a guideline regarding the frequencies of the three clocks CLK₁, CLK₂, CLK₃ must be properly set so that the FIFO storage units 22, 26 and the single-port memory 24 can achieve a constant data flow rate and appear to act as one full-function dual-port storage unit. The guideline is dependent upon the characteristics of the FIFO storage units 22, 26 and the single-port memory 24.

Please continue referring to FIG. 1. In this preferred embodiment, in an attempt to adapting to a full-bandwidth application, the frequency F₂ of the clock CLK₂ is preferrably equal to or larger than the sum of the frequencies F₁, F₃ of the corresponding clocks CLK₁ and CLK₃. For example, assuming that the FIFO storage units 22, 26, and the single-port memory 24 each operate with the same data width of 24 bits, the data receiving rate for the FIFO storage unit 22 is 24 bits×F₁, the data outputting rate for the FIFO storage unit 22 is 24 bits×F₂, the data receiving rate for the single-port memory 24 is 24 bits×F₂, the data outputting rate for the single-port memory 24 is 24 bits×F₂, the data receiving rate for the FIFO storage unit 26 is 24 bits×F₂, and the data outputting rate for the FIFO storage unit 26 is 24 bits×F₃. Please note that the frequency F₁ of the clock CLK₁ and the frequency F₃ of the clock CLK₃ are normally preset, for they are usually predominantly determined by the outputting frequency of the preceding circuitry, for example, an LCD controller circuitry, and the receiving frequency of the following component, for example, a display panel, respectively. Therefore, the frequency of the clock CLK₂ needs to be set, in view of the preset frequencies F₁ and F₃, at such a level that the single-port memory 24 does not act as a bottleneck of the data flow, which is inherent to its single port nature.

To address the issue in more detail, please refer to the following derivation in terms of internal and external data flow rates. Because of the read/write mutual exclusion nature of the single-port memory 24, the data flow rate of the single-port memory 24, i.e., the internal data flow rate of the data transfer interface device 10 can be viewed equivalent to half the sum of the data receiving rate and the data outputting rate, that is, 0.5×(24 bits×F₂+24 bits×F₂). On the other hand, the external data flow rate of the data transfer interface device 10, which is the sum of the receiving rate and the outputting rate thereof, can be denoted as 24 bits×F₁+24 bits×F₃. Accordingly, in order for the data transfer interface device 10 to operate as a full-function dual-port storage unit in a full-bandwidth fashion, the internal data flow rate is required to be equal to or larger than the external data flow rate, which renders the following condition:
0.5×(24 bits×F₂+24 bits×F₂)≧24 bits×F₁+24 bits×F₃
That is,
F₂≧F₁+F₃

And as a result, the aforementioned preferrable criterion is so derived. However, such a criterion serves merely as a preferred requirement in order for a full bandwidth application, and is not to be considered as a limitation of the present invention.

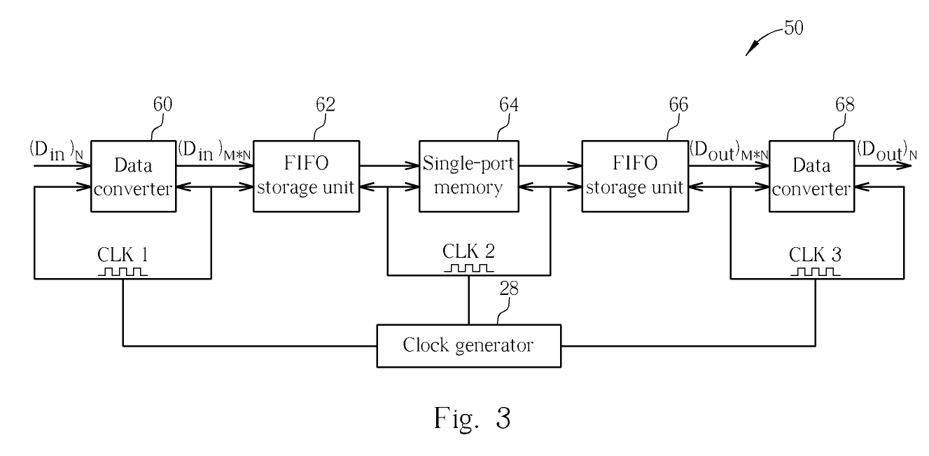

Please further refer to FIG. 3, which shows a block diagram of a data transfer interface device 50 according to an alternate embodiment of the present invention. In FIG. 3, besides of the two FIFO storage units, herein denoted 62 and 64, and the single-port memory, herein denoted 64, as illustrated in FIG. 1, the data transfer interface device 50 also includes a data converter 60 at the input portion, which functions to convert M input data (Dᵢₙ)_{N} with a data width N into input data (Dᵢₙ)_{M×N} with a data width M×N, and a data converter 68 at the output portion, which functions to convert output data (Dₒᵤₜ)_{M×N} with a data width M×N into M output data (Dₒᵤₜ)_{N} with a data width N. It is a common practice in a variety of application fields, such as in LCD monitor controller field, LCD TV controller field, or digital TV controller field, to adopt such data converters when implementing data transfer buffering, and thus the configuration and operation of the data converters 60 and 68 are considered well known to those skilled in the art.

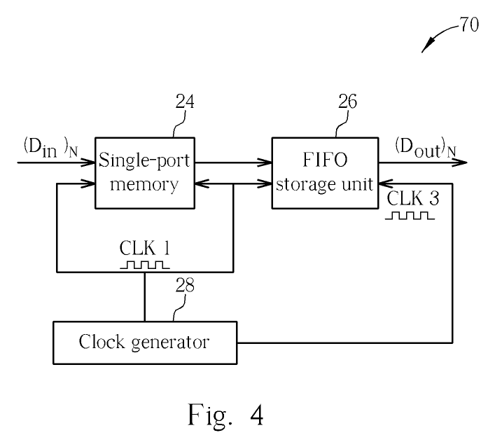

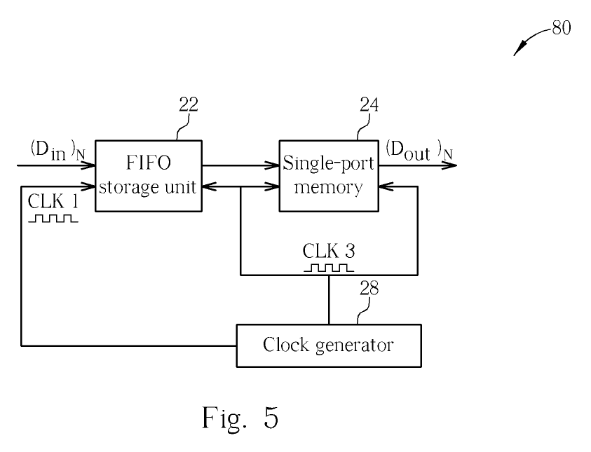

The above-mentioned embodiments in FIG. 1 and FIG. 3 are designed suitable for all sorts of combination of input clock frequency CLK₁ and output clock frequency CLK₃. When it is known, for example, from the setting of the preceding and following circuitries, that the input data rate, and therefore the input clock frequency CLK₁, is higher than the output data rate, and therefore the output clock frequency CLK₃, i.e., F₁>F₃, then the inventive data transfer interface device may be optimized to omit one dual-port FIFO storage unit as shown in FIG. 4. Referring to FIG. 4 in conjunction with FIG. 1, the FIFO storage unit 22 originally positioned in the front is removed and the clock driving the single-port memory 24 is switched to the input clock CLK₁, while such optimized data transfer interface device 70 still functions as a full-function dual-port memory and benefits from even more reduced cost and space. Similarly, when it is known, for example, from the setting of the preceding and following circuitries, that the input data rate, and therefore the input clock frequency CLK₁, is lower than the output data rate, and therefore the output clock frequency CLK₃, i.e., F₁<F₃, then the inventive data transfer interface device may be optimized to omit one dual-port FIFO storage unit as shown in FIG. 5. Referring to FIG. 5 in conjunction with FIG. 1, the FIFO storage unit 26 originally positioned in the rear is removed and the clock driving the single-port memory 26 is switched to the output clock CLK₃, while such optimized data transfer interface device 80 still functions as a full-function dual-port memory and benefits from even more reduced cost and space.

As one can see, the data transfer interface devices 10, 50, 70, 80 in the embodiments shown in FIG. 1, FIG. 3, FIG. 4, and FIG. 5 are considered much cheaper and take up much less space, resulting from the use of a much less complex single-port memory, while provide for the same functionality of a full-function dual-port storage unit.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A data transfer interface apparatus comprising:
a first storage unit for storing an input data according to a first clock and for outputting a first output data according to a second clock;
a single-port memory coupled to the first storage unit, for storing the first output data according to the second clock and for outputting a second output data according to the second clock; and
a second storage unit coupled to the single-port memory, for storing the second output data according to the second clock and for outputting a third output data according to a third clock.

2. The data transfer interface apparatus of claim 1 wherein a frequency of the second clock is equal to or larger than a sum of frequencies of the first and third clocks.

3. The data transfer interface apparatus of claim 1 wherein the single-port memory is an SRAM.

4. The data transfer interface apparatus of claim 1 wherein the first storage unit is a dual-port memory.

5. The data transfer interface apparatus of claim 1 wherein the second storage unit is a dual-port memory.

6. The data transfer interface apparatus of claim 1 wherein the first storage unit is a FIFO storage unit.

7. The data transfer interface apparatus of claim 1 wherein the second storage unit is a FIFO storage unit.

8. The data transfer interface apparatus of claim 1 further comprising:
a first converter unit coupled to the first storage unit for converting M incoming data each having a data length N into the input data having a data length M×N.

9. The data transfer interface apparatus of claim 1 further comprising:
a second converter unit coupled to the second storage unit for converting the third output data having a data length M×N into M outgoing data each having a data length N.

10. A data transfer interface apparatus comprising:
a single-port memory for storing an input data according to a first clock and for outputting a first output data according to a second clock; and
a dual-port memory coupled to the single-port memory, for storing the first output data according to the second clock and for outputting a second output data according to a second clock.

11. The data transfer interface apparatus of claim 10 wherein a frequency of the first clock is larger than a frequency of the second clock.

12. The data transfer interface apparatus of claim 10 wherein the single-port memory is an SRAM.

13. The data transfer interface apparatus of claim 10 wherein the dual-port memory is a FIFO storage unit.

14. A data transfer interface apparatus comprising:
a dual-port memory for storing an input data according to a first clock and for outputting a first output data according to a second clock; and
a single-port memory coupled to the dual-port memory, for storing the first output data according to the second clock and for outputting a second output data according to the second clock.

15. The data transfer interface apparatus of claim 14 wherein a frequency of the first clock is smaller than a frequency of the second clock.

16. The data transfer interface apparatus of claim 14 wherein the single-port memory is an SRAM.

17. The data transfer interface apparatus of claim 14 wherein the dual-port memory is a FIFO storage unit.
